(19) United States
(12) Patent Application Publication
(10) Pub. No.: US 2026/0356082 A1
(43) Pub. Date: Nov. 12, 2026

(54) BURROWING DETERRENT GEOSYNTHETIC COMPOSITE

(71) Applicant: Groupe Solmax, Inc., Longueuil (CA)

(72) Inventors: Jeffery Tommas Hoilman, Chattanooga, TN (US); Mark Cadotte, Calgary (CA); Drew Alan Loizeaux, Georgetown, TN (US); Robert Lee Pierce, JR., Signal Mountain, TN (US); Scott Manning, Chattanooga, TN (US)

(73) Assignee: Groupe Solmax, Inc., Longueuil (CA)

(21) Appl. No.: 19/670,439

(22) Filed: May 7, 2026

Related U.S. Application Data
(60) Provisional application No. 63/802,692, filed on May 9, 2025.

(51) Int. Cl. B32B 15/14; B32B 3/26; B32B 5/02; B32B 7/08; B32B 7/12

(52) U.S. Cl. CPC B32B 15/14; B32B 3/266; B32B 5/022; B32B 5/024; B32B 7/08; B32B 7/12; B32B 2250/03

(57) ABSTRACT

A geosynthetic composite includes a woven geosynthetic, a perforated metal layer, and a nonwoven. The perforated metal layer is arranged between and directly contacts each of the nonwoven and the woven geosynthetic.

### BACKGROUND OF THE INVENTION

Embodiments of the present invention relate generally to geosynthetics, and more specifically, burrowing deterrent geosynthetic composite fabrics.

Geotextiles are permeable textile materials used in civil construction, such as roads and landscapes, to, for example, increase soil stability, provide erosion control, and/or aid in drainage. Geotextiles can be woven, knitted, or non-woven, as well as composites.

Geotextiles are used to stabilize soil on steep slopes, reinforce vegetative growth, and prevent soil erosion. Challenges of such applications include ability to withstand breakdown by natural elements over time, cost, and cumbersome installation. Further, preventing erosion in hydraulic environments, such as streams, banks, ponds, canals, channels, levees, and shorelines, is particularly challenging because the materials float in water and require anchorage to the terrain to keep in place.

### SUMMARY OF THE INVENTION

In one or more embodiments, a geosynthetic composite includes a woven geosynthetic; a perforated metal layer; and a nonwoven; wherein the perforated metal layer is arranged between and directly contacts each of the nonwoven and the woven geosynthetic.

In other embodiments, a method of making a geosynthetic composite includes arranging a perforated metal layer between a woven geosynthetic and a nonwoven; adhering the woven geosynthetic to the perforated metal layer, and the perforated metal layer to the nonwoven to form the geosynthetic composite, such that the perforated metal layer is arranged between and directly contacts each of the nonwoven and the woven geosynthetic.

It is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the present invention. It is important, therefore, that the claims be regarded as including such equivalent constructions insofar as they do not depart from the spirit and scope of the present invention.

Other advantages and capabilities of the present invention will become apparent from the following description taken in conjunction with the accompanying drawings showing the elements and the various aspects of the present invention.

### BRIEF DESCRIPTION OF THE OF DRAWINGS

The disclosure below makes reference to the annexed drawings wherein:

FIG. 1 is a top view of a geosynthetic composite according to embodiments;

FIG. 2 is a top view of a geosynthetic composite according to embodiments; and

FIG. 3 is a geosynthetic composite anchored to an inclined landscape.

### DETAILED DESCRIPTION OF THE INVENTION

For a fuller understanding of the nature and desired objects of this invention, reference should be made to the above and following detailed description taken in connection with the accompanying figures. When reference is made to the figures, like reference numerals designate corresponding parts throughout the several figures.

As mentioned above, geotextiles are used to stabilize soil on steep slopes, reinforce vegetative growth, and/or prevent soil erosion. When animals, such as rodents, burrow in land areas beneath where the geotextiles are installed, the borrows can cause more erosion than originally intended to protect, and in many cases, the structural damage can be catastrophic.

Accordingly, described herein are a geosynthetic composite, method of making, and method of using, which prevent animals from burrowing through and beneath the geosynthetic composite, causing structural damage, and preventing the composite from stabilizing soils, thereby preventing erosion, and promoting revegetation. The geosynthetic composite include a woven geosynthetic, a nonwoven, and a perforated metal layer between the woven geosynthetic and the nonwoven. In some embodiments, the geosynthetic composite is secured to soil, landscape, and/or terrain with a plurality of terrain anchors, which anchor the geosynthetic composite in place and protect the soil, landscape, and/or terrain.

The geosynthetic composite and methods of making and using thereof provide various advantages for use in a variety of systems, including those used to stabilize soil on steep slopes, reinforce vegetative growth, and/or prevent soil erosion. The geosynthetic composite 100 is engineered to prevent animal entanglement. Animals include burrowing animals and rodents, including but not limited to, moles, gophers, prairie dogs, squirrels, chipmunks, great gerbils, groundhogs, skunks, voles, raccoons, platypus, pangolins, rabbits, armadillos, rats, and weasels. The perforated metal layer includes openings sized to deter burrowing, e.g., up to six inches (in) or 2.54 centimeters (cm) in some embodiments, discourages development of animal habitat. The geosynthetic composite also provides the following advantages: corrosion and ultraviolet (UV) resistance; reduced risk of failure compared to other geosynthetics; secure placement; permeability; erosion control; a lower carbon footprint than other geosynthetics; significant cost savings compared to traditional hard armoring systems; light weight and easy transport into areas with access challenges; simple visual inspections for easy repair.

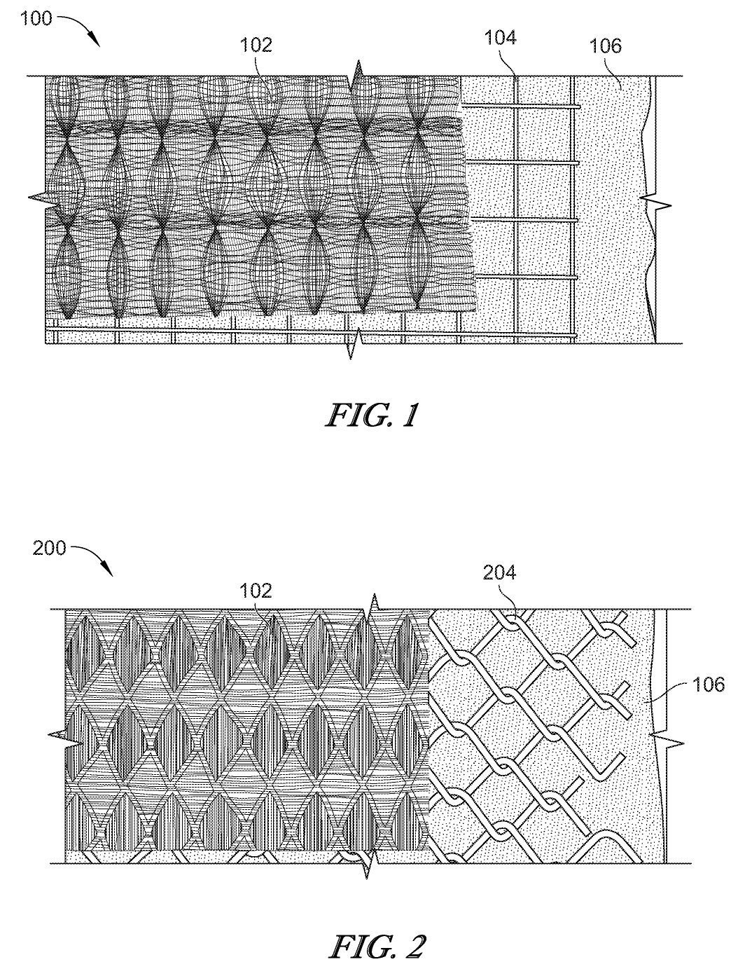

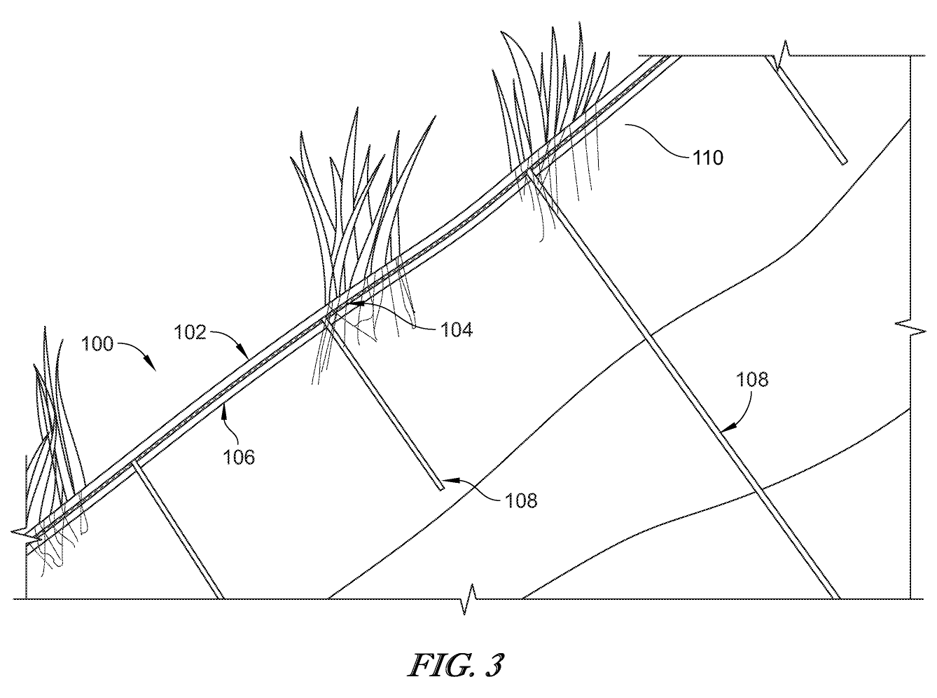

FIGS. 1 and 2 illustrate a geosynthetic composite 100, 200 according to one or more embodiments. The geosynthetic composites 100, 200 includes a nonwoven 106, a perforated metal layer 104, 204 and a woven geosynthetic 102. The perforated metal layer 104, 204 is arranged between and directly contacts each of the nonwoven 106 and the woven geosynthetic 102. In some embodiments, the geosynthetic composite 100 includes only the woven geosynthetic 102, the perforated metal layer 104, 204, and the nonwoven 106, and does not include any additional layers or materials between these layers or outside these layers.

### Woven geosynthetic

Non-limiting examples of the woven geosynthetic 102 include a three-dimensional woven geotextile, geotextile composite, synthetic turf geotextile composite, a concrete filled geotextile composite, a dimensionally stable reinforced geosynethetic, a stitch-bonded geosynthetic, or any combination thereof.

The woven geosynthetic 102 is a single layer fabric in some embodiments. In other embodiments, the woven geosynthetic 102 is a multiple layer fabric. In one or more embodiments, the woven geosynthetic 102 is a double layer or a triple layer fabric.

The woven geosynthetic 102 has two principal directions, one being the warp direction and the other being the weft direction. The weft direction is also referred to as the fill direction. The warp direction is the length wise, or machine direction. The fill or weft direction is the direction across the fabric, from edge to edge, or the direction traversing the width of the weaving machine. Thus, the warp and fill directions are generally perpendicular to each other. The sets of yarns or monofilaments running in each direction are referred to as the warp yarns and the fill yarns, respectively.

The woven geosynthetic 102 includes monofilaments or yarns woven in the warp and weft/fill directions. The geometric cross-sectional shape of the yarns or monofilaments are not limited in shape. In some embodiments, the cross-sectional shape is, but not limited to, round, non-round, oval, square, triangular, rectangular, trapezoidal, trilobal, multi-lobal, and other geometrically-shaped monofilaments.

In embodiments, at least a portion of the monofilaments used in the woven geosynthetic 102 are monofilament shrink yarns. In some embodiments, all of the monofilaments used in woven geosynthetic are monofilament shrink yarns. Alternatively, in some other embodiments, none of the monofilaments used in woven geosynthetic 102 are monofilament shrink yarns. Monofilament shrink yarns have a greater differential heat shrinkage characteristic compared to non-shrink yarns. In other words, shrink yarns have greater shrinkage than non-shrink yarns when exposed to the same heat and/or temperature conditions. Although non-shrink yarns can nominally shrink, such shrinkage is relatively insignificant as compared to the degree or amount of shrinkage of the shrink yarns at like heat and/or temperature conditions.

In some embodiments, the warp and fill monofilaments or yarns of the woven geosynthetic 102 include the same material(s) and/or polymers. In other embodiments, both the warp and fill monofilaments or yarns are shrink yarns, and shrink yarns in the warp and fill include different polymers. In some other embodiments, the warp and fill monofilaments or yarns are shrink yarns and include the same polymers.

In one or more embodiments, the monofilaments or yarns of the woven geosynthetic 102 are thermoplastic polymers. In other embodiments, the monofilaments include natural fibers. Polymers for the monofilaments or yarns of the woven geosynthetic 102 include, but are not limited to, polyamides (for example, any nylon), polyimides, polyesters (for example, high tenacity polyesters, polyethylene terephthalate, polybutylene terephthalate, and aromatic polyesters), polyacrylonitriles, polyphenylene oxides, fluoropolymers, acrylics, polyolefins (for example, low density polyethylene (LDPE), linear low density polyethylene (LLDPE), high density polyethylene (HDPE), co-polymers of polyethylene, polypropylene, and higher polyolefins), polyphenylene sulfide, polyetherimide, polyetheretherketone, polylactic acid (also known as polylactide), aramids (for example, para-aramids), aromatic ether ketones, vinalon, and the like, and blends of such polymers. The monofilaments and/or yarns include, in some embodiments, additives, such as dyes, plasticizers, etc., employed in the textile industry.

In one or more embodiments, the monofilaments and/or yarns of the woven geosynthetic 102 include polyamides, polyimides, polyesters, polyacrylonitriles, polyphenylene oxides, fluoropolymers, acrylics, polyolefins, polyphenylene sulfide, polyetherimide, polyetheretherketone, polylactic acid, aramids, aromatic ether ketones, vinalon, or any combination thereof. In one or more embodiments, the monofilaments and/or yarns include polypropylene, polyethylene, high tenacity polyester, or any combination thereof.

In some embodiments, each monofilament has a denier of about 300 (333 decitex) to about 2000 (2222 decitex). In other embodiments, each monofilament has a denier of about 500 (555 decitex) to about 1100 (1222 decitex).

In one or more embodiments, the woven geosynthetic is either a single layer, three-dimensional woven fabric or a double layer three-dimensional woven fabric. According to other embodiments, the woven geosynthetic 102 is a planar, single-layered homogeneous fabric woven from cross-sectional multi-lobe filament yarns having different heat shrinkage characteristics such that, when heated, the fabric forms a thick three-dimensional fabric with a cuspated profile. In embodiments, the three-dimensional fabric is a pyramidal fabric with two sets of multi-lobe filament yarns interwoven in substantially perpendicular direction to each other, each of the multi-lobe filament yarns having pre-determined, different heat shrinkage characteristics such that, upon heating, the fabric forms a three-dimensional, cuspated profile. In other embodiments, the three-dimensional fabric is woven in a “waffle weave” or “honeycomb” weave pattern, which provides a generally planar, single layer fabric with a distinctive look of adjacent pyramids on one side of the fabric that oppose and are offset from adjacent pyramids on the other side of the fabric.

In some embodiments, the monofilament and/or yarns utilized to produce the woven geosynthetic 102 are biaxially heat shrinkable. That is, upon being heated, the filament yarns will shrink in both directions. However, the amount of heat shrinkage is different for each filament yarn depending upon its position within the woven fabric. Hence, when the woven, initially planar fabric is subjected to heat, as from a hot steam or water bath, the filaments in opposing directions are shrunk proportionally to the differing levels of heat shrinkage with which each filament was provided. Significantly, by arranging the filaments in a predetermined, well-known fashion based upon their level of heat shrinkage, the initially planar fabric becomes thicker and more three-dimensional in shape. The filaments provide a zig-zag cross-section and take up a substantially greater volume than when the fabric is relatively planar. In some embodiments, the thickness of the three-dimensional fabric increases to at least about 0.25 inches (250 mils). In other embodiments, the thickness of the fabric can grow from about 0.25 inches (250 mils) to about 0.5 inches (500 mils).

In contrast to many woven geosynthethics with large opening in which burrowing animals can become trapped, the woven geosynthetic 102 includes small openings and a high tensile strength, which in combination deter animals from burrowing under and/or through the geosynthetic composite 100.

In one or more embodiments, the woven geosynthetic 102 has openings/apertures measuring 5 square millimeters or less, which prevent animal entrapment.

In some embodiments, the woven geosynthetic 102 has a tensile strength of about 2,000 to about 7,000 pounds/foot in the warp and fill directions, using the American Society for Testing and Materials (ASTM) Standard Test Method D-6818. In other embodiments, the woven geosynthetic 102 has a tensile strength of about 3,000 to about 6,000 pounds/foot in the warp and fill directions, using the same ASTM Test Method, D-6818. In yet other embodiments, the woven geosynthetic 102 has a tensile strength of about or in any range between about 2,000, 2,500, 3,000, 3,500, 4,000, 4,500, 5,000, 5,500, 6,000, 6,500, and 7,000 pounds/foot in the warp and fill directions.

In one or more embodiments, the woven geosynthetic 102 has a UV resistance of about 100% after about 3,000 to about 6,000 hours of UV exposure, as measured by ASTM D 4355 Standard Test Method for Deterioration of Geotextiles by Exposure to Light, Moisture, and Heat in a Xenon Arc-Type Apparatus. In other embodiments, the woven geosynthetic 102 has a UV resistance of about 100% after about or any range between about 3,000, 3,500, 4,000, 4,500, 5,000, 5,500, and 6,000 hours of UV exposure, as measured by ASTM D 4355 Standard Test Method for Deterioration of Geotextiles by Exposure to Light, Moisture, and Heat in a Xenon Arc-Type Apparatus.

In some embodiments, the woven geosynthetic 102 has a plain weave pattern, a twill weave pattern (for example, a 1/3 twill weave, a 2/1 twill weave, a 2/2 twill weave, or a 3/1 twill weave), a basket weave pattern, or a combination thereof. A plain weave is characterized by a repeating pattern where each warp yarn is woven over one fill yarn and then woven under the next fill yarn. A twill weave, relative to the plain weave, has fewer interlacings in a given area. A twill weave is named by the number of fill yarns that a single warp yarn goes over and then under. For example, in a 2/2 twill weave, a single warp end weaves over two fill yarns and then under two fill yarns. In a 3/1 twill weave, a single warp end weaves over three fill yarns and then under one fill yarn. For fabrics being constructed from the same type and size of yarn, with the same thread or monofilament densities, a twill weave has fewer interlacings per area than a corresponding plain weave fabric.

### Perforated metal layer

In addition to the woven geosynthetic 102 with the optimally sized small openings and high tensile strength, which prevent animal burrowing and entrapment, the perforated metal layer 104, 204, sandwiched between the woven geosynthetic 102 and the nonwoven 106, provides an increased factor of safety for deterring and preventing animal burrowing. In one or more embodiments, the perforated metal layer 104, 204 is a metal mesh, a welded metal layer, a twisted metal layer, a braided metal layer, a coated metal layer, a stainless steel layer, a galvanized metal layer, a woven mesh fabric, or any combination thereof.

The sizes of the openings/apertures in the perforated metal layer 104, 204 are appropriately sized to prevent animal burrowing, and the openings/apertures are selected based on animal size. In some embodiments, the perforated metal layer 104, 204 has apertures/openings with diameters of about 1 to about 6 inches. In other embodiments, the perforated metal layer 104, 204 has apertures/openings with diameters of about 2 to about 5 inches. In other embodiments, the perforated metal layer 104, 204 has apertures/openings with diameters of about or in any range between about 1, 2, 3, 4, 5, and 6 inches.

In one or more embodiments, the perforated metal layer 104, 204 includes a chain link fabric mesh. In other embodiments, the perforated metal layer 104, 204 includes a galvanized steel vinyl coated wire fencing.

### Nonwoven fabric

In one or more embodiments, the nonwoven 106 is a geotextile, a geosynthetic grid, a geosynthetic membrane, a geosynthetic net, a drainage composite, or any combination thereof. The nonwoven 106 has a structure of individual, staple, and/or continuous fibers that are randomly interlaid and not woven together, as in a woven or knitted fabric.

Nonwoven fiber webs include needle-punched webs, meltblown webs, spunbound webs, cross-lapped webs, bonded carded webs, airlaid webs, wetlaid webs, coform webs, carded webs, hydraulically entangled webs, and any combination thereof.

Nonwoven geotextiles are continuous sheet nonwoven fibers or yarns. The sheets are flexible and permeable.

Geosynthetic grids have an open grid-like appearance, with fibers or yarns extending in two perpendicular directions.

Geosynthetic nets are open grid-like materials formed by two sets of coarse, parallel, extruded polymeric strands intersecting at a constant acute angle. The network forms a sheet with in-plane porosity.

Geosynthetic membranes are continuous flexible sheets manufactured from one or more synthetic materials, which are impermeable, or substantially impermeable.

Geosynthetic composites include a combination of two or more geosynthetic material layers, such as, for example, two or more of a geotextile, geosynthetic net, geosynthetic grid, and geosynthetic membrane.

The nonwoven 106 includes polypropylene fibers, polyethylene fibers, natural fibers, synthetic fibers, a blend of natural and synthetic fibers, or a combination thereof

The fibers used to form the nonwoven 106 are natural fibers, synthetic polymeric fibers, or a combination thereof. In some embodiments, the synthetic polymeric fibers are polypropylene fibers, polyethylene fibers, or a combination thereof. In some embodiments, the fibers are staple fibers. According to one or more embodiments, the synthetic polymeric fibers are a homopolymer of polypropylene (PP), high density polyethylene (HDPE), medium density polyethylene (MDPE), low density polyethylene (LDPE), linear low-density polyethylene (LLPE), ultra-low density polyethylene (ULPE), or any combination thereof. According to some embodiments, the fibers are a blend of about 1% to about 40% polyethylene (e.g., HDPE, MDPE, LDPE, LLPE, or ULPE) and 99% to about 60% polypropylene. In some embodiments, the fibers are a blend of 95% polypropylene and 5% polyethylene. In some other embodiments, the fibers are made from a recycled polymer.

According to some embodiments, the synthetic polymeric fibers of the nonwoven 106 include, but are not limited to, polyamides (for example, any of the nylons), polyimides, polyesters (for example, high tenacity polyesters, polyethylene terephthalate, polybutylene terephthalate, and aromatic polyesters), polyacrylonitriles, polyphenylene oxides, fluoropolymers, acrylics, polyolefins (for example, low density polyethylene (LDPE), linear low density polyethylene (LLDPE), high density polyethylene (HDPE), co-polymers of polyethylene, polypropylene, and higher polyolefins), polyphenylene sulfide, polyetherimide, polyetheretherketone, polylactic acid (also known as polylactide), aramids (for example, para-aramids, and meta-paramids), aromatic ether ketones, vinalon, and the like, and blends of such polymers which can be formed into microfilaments. Further, in one or more embodiments, the fibers include other agents, materials, dyes, plasticizers, etc. which are employed in the nonwoven industry.

Non-limiting examples of natural fibers for the nonwoven 106 include wood pulp fibers, plant-based fibers, cotton fibers, reconstituted cellulose fibers, or any combination thereof.

The geometric cross-sectional shape of the yarns and/or monofilaments of the nonwoven 106 are not limited in shape. In some embodiments, the cross-sectional shape is, but not limited to, round, non-round, oval, square, triangular, rectangular, trapezoidal, trilobal, multi-lobal, or other geometrically-shaped monofilaments and/or yarns.

In some embodiments, the filaments and/or yarns of the nonwoven 106 are bonded together by a polymeric resin. In other embodiments, the filaments and/or yarns of the nonwoven 106 are bonded together by heat treatment (i.e., heat set). Heat treatment is infrared radiation, hot calendaring, or any other suitable heat source, and at temperature ranges from about 110 to about 175° C.

### Geosynthetic composite

In some embodiments, a method of making the geosynthetic composite includes arranging a perforated metal layer between a woven geosynthetic and a nonwoven; and adhering the woven geosynthetic to the perforated metal layer, and the perforated metal layer to the nonwoven to form the geosynthetic composite, such that the perforated metal layer is arranged between and directly contacts each of the nonwoven and the woven geosynthetic.

In some embodiments, the layers (woven geosynthetic 102, perforated metal layer 104, and nonwoven 106) of the geosynthetic composite 100 are combined and adhered to one another with an adhesive. When included, the adhesive is arranged between woven geosynthetic 102 and the perforated metal layer 104; between the perforated metal layer 104 and the nonwoven 106; or between the woven geosynthetic 102 and the perforated metal layer 104, and between the perforated metal layer 104 and the nonwoven 106.

Non-limiting examples of adhesives for the geosynthetic composite 100 include a polyolefin adhesive (e.g., an amorphous polyolefin adhesive), a sprayable latex adhesive, a hot-melt adhesive, a thermoplastic polymer adhesive, an amorphous polyolefin adhesive, an ethylene vinyl acetate adhesive, a polypropylene adhesive, a polyethylene adhesive, a polypropylene and polyethylene blended adhesive, a polyvinyl acetate adhesive, an epoxy resin adhesive, an acrylate adhesive, an amorphous polyolefin (APO), a thermoplastic olefin (TPO), or any combination thereof.

In other embodiments, the layers (woven geosynthetic 102, perforated metal layer 104, and nonwoven 106) of the geosynthetic composite 100 are combined and bonded to one another. In one or more embodiments, the woven geosynthetic 102 and the perforated metal layer 104 are bonded to one another. In other embodiments, the perforated metal layer 104 and the nonwoven 106 are bonded to one another. Still, in other embodiments, each of the woven geosynthetic 102 and the perforated metal layer 104, and the perforated metal layer 104 and the nonwoven 106, are bonded to one another. Non-limiting examples of types of bonding include by heat treatment, such as by, infrared radiation, hot calendaring, or any other suitable heat source treatment.

In some embodiments, the layers (woven geosynthetic 102, perforated metal layer 104, and nonwoven 106) of the geosynthetic composite 100 are combined and adhered to one another with a plurality of fasteners. In embodiments, the geosynthetic composite 100 include a plurality of fasteners extending through and securing the woven geosynthetic 102, the perforated metal layer 104, and the nonwoven 106 to one another. Non-limiting examples of each of the fasteners include a pin, an anchor, a stake, a hog ring, a tie, a yarn, or a combination thereof.

As shown in FIG. 2, in some embodiments, the geosynthetic composite 100 includes a plurality of terrain anchors 108 extending through the geosynthetic composite 100, securing the geosynthetic composite 100 to the ground/terrain 110.

In some embodiments, the terrain anchors 108 securing the geosynthetic composite 100 to the soil/ground/terrain 110 are wire staples (e.g., U-shaped wire staples), metal pins, or a combination thereof. In one or more embodiments, wire staples have a thickness of at least 8 gauge (at least 4.3 millimeters). In some embodiments, metal pins include steel and have a diameter of at least 3/16 inches (at least 4.7 millimeters), and include a steel washer (e.g., 1.5 inch (38 millimeters) at the head of the metal pin. In one or more embodiments, the terrain anchors 108 include stainless steel. Securing the geosynthetic composite 100 to the terrain/soil 110 provides a sustainable burrow deterrent system.

In embodiments, the plurality of terrain anchors 108 (e.g., wire staples and/or metal pins) are driven through the geosynthetic composite 100 and flush to the terrain/soil 100 surface. In some embodiments, depending on slope of the terrain/soil 100, one terrain anchor 108 is used every 1-3 square yards. In embodiments, prior to installing the geosynthetic composite 100 and terrain anchors 108, the area of installation is graded and compacted to remove rocks, clods, vegetation, and/or other obstructions so that the installed geosynthetic composite 100 will have direct contact with terrain/soil 110 surface. In some embodiments, about 2 to 3 inches (50-75 millimeters) of topsoil is loosened, final amendments, such as lime and fertilizer are incorporated into the soil if needed, and/or seed are applied to the soil surface before or after installation.

In one or more embodiments, a method of stabilizing soil and/or reinforcing vegetation, while preventing burrowing of animals from burrowing and de-stabilizing and soil and/or vegetation, includes placing a geosynthetic composite on a soil/landscape/terrain; securing the fabric to the soil/landscape/terrain; and distributing soil and/or seed onto the geosynthetic composite such that the section of soil/landscape/terrain is quickly revegetated and thereby protected from erosion.

In one or more embodiments, the geosynthetic composite 100, or one or both of the woven geosynthetic 102 and the nonwoven 106, includes a vegetative-sustaining material. Non-limiting examples of vegetative-sustaining material include soil, mulch, compost, hydroseeding, sand, fertilizer, or any combination thereof. The vegetative-sustaining material is applied to a surface of and/or embedded within the geosynthetic composite 100, or one or both of the woven geosynthetic and the nonwoven 106 and the nonwoven 106.

Yet, in other embodiments, the geosynthetic composite 100, or one or both of the woven geosynthetic 102 and the nonwoven 106, is pre-seeded with plants, hydro-seeded, has live plants attached thereto, or any combination thereof. The seeds and/or live plants may be applied to a surface of and/or embedded within the geosynthetic composite 100, or one or both of the woven geosynthetic 102 and the nonwoven 106.

The geosynthetic composite can be used in a variety of applications, including but not limited to, embankments, canals, levees, slopes, lagoons, channels, shorelines, berms, ponds, creeks, lakes, streams, rivers, intercoastal areas, dams, overflow regions, spillways, abutments, landfills, utility protection areas, and reservoirs, weirs.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt.%, or, more specifically, 5 wt.% to 20 wt.%”, is inclusive of the endpoints and all intermediate values of the ranges of “5 wt.% to 25 wt.%,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. As used herein, the terms “comprising” “including,” “having,” “containing,” “involving,” and the like are to be understood to be open-ended, i.e., to mean “including” but not limited to, unless otherwise noted. “About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ± 10% or ± 5% of the stated value. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Reference throughout the specification to “an aspect”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

The terms “about,” “substantially,” “approximately,” and variations thereof, are intended to include the degree of error associated with measurement of the particular quantity based upon the equipment available at the time of filing the application. For example, “about” can include a range of ± 8% or 5%, or 2% of a given value.

The flowchart and block diagrams in the Figures illustrate possible implementations of fabrication and/or operation methods according to various embodiments of the present invention. Various functions/operations of the method are represented in the flow diagram by blocks. In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

While the preferred embodiments to the invention have been described, it will be understood that those skilled in the art, both now and in the future, may make various improvements and enhancements which fall within the scope of the claims which follow. These claims should be construed to maintain the proper protection for the invention first described.

What is claimed is:

1. A geosynthetic composite comprising:
a woven geosynthetic;
a perforated metal layer; and
a nonwoven;
wherein the perforated metal layer is arranged between and directly contacts each of the nonwoven and the woven geosynthetic.

2. The geosynthetic composite of claim 1, wherein the woven geosynthetic is a three-dimensional woven geotextile, geotextile composite, synthetic turf geotextile composite, a concrete filled geotextile composite, a dimensionally stable reinforced geosynethetic, a stitch-bonded geosynthetic, or any combination thereof.

3. The geosynthetic composite of claim 1, wherein the perforated metal layer is a metal mesh, a welded metal layer, a twisted metal layer, a braided metal layer, a coated metal layer, a stainless steel layer, a galvanized metal layer, a woven mesh fabric, or any combination thereof.

4. The geosynthetic composite of claim 1, wherein the nonwoven layer is a geotextile, a geosynthetic grid, a geosynthetic membrane, a geosynthetic net, a geosynthetic composite, or any combination thereof.

5. The geosynthetic composite of claim 1, further comprising a plurality of fasteners extending through and securing the woven geosynthetic, the perforated metal layer, and the nonwoven to one another.

6. The geosynthetic composite of claim 5, wherein each of the plurality of fasteners is a pin, an anchor, a stake, a hog ring, a tie, a yarn, or a combination thereof.

7. The geosynthetic composite of claim 1, further comprising an adhesive between the woven geosynthetic and the perforated mesh; the perforated metal layer and the nonwoven; or both.

8. The geosynthetic composite of claim 1, wherein the woven geosynthetic and the perforated metal layer; the perforated metal layer and the nonwoven; or both, are bonded to one another.

9. The geosynthetic composite of claim 1, further comprising a plurality of terrain anchors extending through the geosynthetic composite.

10. A method of making a geosynthetic composite, the method comprising:
arranging a perforated metal layer between a woven geosynthetic and a nonwoven;
adhering the woven geosynthetic to the perforated metal layer, and the perforated metal layer to the nonwoven to form the geosynthetic composite, such that the perforated metal layer is arranged between and directly contacts each of the nonwoven and the woven geosynthetic.

11. The method of claim 10, wherein the woven geosynthetic is a three-dimensional woven geotextile, geotextile composite, synthetic turf geotextile composite, a concrete filled geotextile composite, a dimensionally stable reinforced geosynethetic, or any combination thereof.

12. The method of claim 10, wherein the perforated metal layer is a metal mesh, a welded metal layer, a twisted metal layer, a braided metal layer, a coated metal layer, a stainless steel layer, a galvanized metal layer, a geogrid, a woven mesh fabric, or any combination thereof.

13. The method of claim 10, wherein the nonwoven layer is a geotextile, a geosynthetic grid, a geosynthetic membrane, a geosynthetic net, a drainage composite, or any combination thereof.

14. The method of claim 10, further comprising a plurality of fasteners extending through and securing the woven geosynthetic, the perforated metal layer, and the nonwoven to one another.

15. The method of claim 10, wherein each of the plurality of fasteners is a pin, an anchor, a stake, a hog ring, a tie, a yarn, or a combination thereof.

16. The method of claim 10, further comprising an adhesive between the woven geosynthetic and the perforated metal layer; the perforated metal layer and the nonwoven; or both.

17. The method of claim 10 wherein the woven geosynthetic and the perforated metal layer; the perforated metal layer and the nonwoven; or both, are bonded to one another.

18. The method of claim 10, further comprising a plurality of terrain anchors extending through the geosynthetic composite.
